(19) United States
(12) Patent Application Publication
(10) Pub. No.: US 2025/0279273 A1
(43) Pub. Date: Sep. 4, 2025

(54) METHOD FOR GENERATING HIGH-INTENSITY PULSES OF CONTINOUS-SPECTRUM UV RADIATION AND DEVICE FOR CARRYING OUT SAME

(71) Applicant: OBSHCHESTVO S OGRANICHENNOI OTVETSTVENNOSTIU <<NAUCHNO-PROIZVODSTVENNOE PREDPRIIATIE, Moscow (RU)

(72) Inventors: Iakov Abrammerovich GOLDSHTEIN, Moscow (RU); Sergei Gennadevich KIREEV, Moscow (RU); Sergei Gennadevich SHASHKOVSKII, Moscow (RU)

(21) Appl. No.: 18/857,509

(22) PCT Filed: Dec. 22, 2022
(86) PCT No.: PCT/RU2022/050408

§ 371 Date: Oct. 17, 2024

(30) Foreign Application Priority Data
Apr. 29, 2022 (RU) 2022111885

(51) Int. Cl. H01J 61/56; H01J 61/90

(52) U.S. Cl. CPC H01J 61/56; H01J 61/90

(57) ABSTRACT

The means for producing pulsed ultraviolet (UV) radiation with a continuous spectrum is disclosed for the purposes of disinfection and sterilization. A method for generating high-intensity pulses of UV radiation using a current source involves forming a constricted arc discharge in an interelectrode gap of a discharge channel of a xenon pulsed lamp having quartz walls, and then supplying to said channel, by means of a discharge circuit switcher, a pulse of a main discharge having a current density sufficient for the brightness temperatures of the plasma in the discharge channel to reach more than 7000 K, thereby generating a pulse of radiation with a continuous spectrum, wherein the geometric parameters of the discharge channel are related to the parameters of the discharge circuit by a given ratio. The method is carried out using a corresponding device.

### TECHNICAL FIELD

The group of inventions relates to the field of electrical engineering, and more particularly to means for producing pulsed ultraviolet (UV) radiation with a continuous spectrum by using a high-current discharge in tubular pulsed lamps having a quartz shell filled with an inert gas, preferably xenon, operating in a stroboscopic mode and used for disinfecting and sterilizing indoor air and indoor objects or wastewater.

### BACKGROUND OF THE INVENTION

Currently, pulsed UV technologies for room disinfection, wastewater treatment and others are being intensively developed. Back in 1984, Tatsumi Hiramoto proposed to use radiation from pulsed lamps for disinfection (U.S. Pat. No. 4,464,336). However, the widespread adoption of pulsed technologies is constrained by the low lifetime of pulsed xenon lamps generating radiation with a predominant yield in the ultraviolet region of the spectrum.

The pulsed xenon lamps are characterized by a continuous radiation spectrum close in spectral composition to black-body radiation. According to the Wien's displacement law, the highest UV radiation yield in the bactericidal band from 200 to 300 nm should be expected at brightness temperatures of 10000 K to 14000 K, which corresponds to the specific radiation power (energy luminosity) of the electric-discharge xenon plasma of a pulsed lamp from 56.0 kW/cm² to 385.0 kW/cm². However, the realization of such powerful operational modes of pulsed lamps will be accompanied by high-shock, thermal and radiation effects on the inner surface of a quartz channel, which leads to a sharp reduction in the service life of the pulsed lamps due to their destruction or accelerated loss of transparency of a quartz wall.

It is known that the fracture durability of the shell of tubular lamps in a stroboscopic operational mode increases from 2 to 5 times when a “pilot arc” lamp ignition circuit is used. A “pilot” arc discharge of relatively low power creates initial conductivity across the cross-section of the channel and equalizes shock loads on the surface of a bulb, which increases the lifetime of the lamp. At the same time, a pulse duration, a peak current, a peak power and radiation characteristics do not change.

RU 2370850 C2 (publ. 20 Oct. 2009) discloses a method for generating high-intensity pulses of continuous-radiation UV radiation, which consists in applying a pre-ionization pulse prior to applying, by a discharge circuit switch, a main pulse sufficient to achieve plasma brightness temperatures of more than 7000 K in the discharge channel. The main discharge pulse having a duration of less than 10 microseconds is applied at the time of the maximum current of the pre-ionization pulse. Furthermore, the pre-ionization pulse is applied with a duration more than 10 times longer than the main pulse duration and with a pre-ionization pulse current more than 10 times lower than the main discharge current.

RU 2370850 C2 (publ. 20 Oct. 2009) discloses a means for generating high-intensity pulses of continuous-radiation UV radiation, which comprises a xenon pulsed lamp having quartz walls of a discharge channel. The lamp is connected to a first power supply unit and a storage capacitor through a switch to form a main discharge circuit, and to a second power supply unit and a storage capacitor to form a pre-ionization discharge circuit. The device also comprises an initiation unit and a control unit.

The disadvantages of the known method and device are as follows.

Pre-ionization is carried out to form a discharge that is uniform in cross-section, resulting in reduced shock loads on the quartz lamp shell, which extends the service life before fracture, but does not reduce thermal and radiation loads on the inner surface of the quartz wall.

Accordingly, even with complete pre-ionization of the discharge channel, the formation of high-current stage of the main discharge occurs near the quartz wall, which at brightness temperatures of more than 7000 K inevitably leads to the intensification of plasma-chemical processes on the inner surface of the quartz wall, accompanied by its modification and, as a consequence, to a sharp increase in the absorption of UV radiation in the modified layer, which reduces the UV yield of the pulsed lamp and significantly limits the lifetime.

### SUMMARY OF THE INVENTION

The present group of inventions is aimed at solving the problems consisting in limitation of brightness of UV radiation pulses and low lifetime of xenon-filled pulsed lamps with quartz walls.

The technical result of the claimed group of inventions is an increase in the efficiency of generation of UV radiation by pulsed xenon lamps with quartz walls, while increasing their service life.

The technical result is achieved by a method for generating high-intensity pulses of continuous-spectrum UV radiation, in which a constricted arc discharge is formed by a current source in an interelectrode gap of a discharge channel of a pulsed xenon lamp with quartz walls, and a main discharge pulse having a current density sufficient to achieve plasma brightness temperatures of more than 7000 K in the discharge channel is then supplied to the discharge channel by a switch of a discharge circuit, thereby generating a continuous-spectrum radiation pulse with ultraviolet output. The geometric parameters of the discharge channel of the pulsed xenon lamp are related to the parameters of the discharge circuit by the following ratio:

$$dl > 1 {0}^{3} ( 0.2 + k ) {U}^{2} {C}^{3 / 4} {L}^{- 1 / 4} ,$$

where d is a diameter of the discharge channel of the lamp, cm, l is a length of the discharge channel of the lamp, cm, U is a voltage on a storage capacitor, V, C is a capacitance of the storage capacitor, F, L is an inductance of the discharge circuit, H, k=2.5*10⁻⁵ (T_{b}−7000 K) is a dimensionless coefficient that takes into account an increase in absorption of UV radiation at brightness temperatures T_{b} of the plasma discharge more than 7000 K.

As a rule, the constricted arc discharge is formed in a continuous burning mode or at least 10⁻³ second prior to each main discharge pulse.

The main discharge pulse is supplied with a current density of at least 3 kA/cm².

The main discharge pulses are supplied with a repetition rate of not more than 200 Hz.

The described method is performed by a device for generating high-intensity pulses of continuous-spectrum UV radiation, which comprises a pulsed xenon lamp having quartz walls of a discharge channel and connected to a power supply and a storage capacitor through a switch to form a discharge circuit, an initiation unit, a current source for forming a constricted arc discharge, and a control unit. The geometric parameters of the discharge channel of the pulsed lamp are related to the parameters of the discharge circuit by the following ratio:

$$dl > 1 {0}^{3} ( 0.2 + k ) {U}^{2} {C}^{3 / 4} {L}^{- 1 / 4} ,$$

where d is the diameter of the discharge channel of the lamp, cm, l is the length of the discharge channel of the lamp, cm, U is the voltage on the storage capacitor, V, C is the capacitance of the storage capacitor, F, L is the inductance of the discharge circuit, H, k=2.5*10⁻⁵ (T_{b}−7000 K) is the dimensionless coefficient that takes into account the increase in absorption of UV radiation at brightness temperatures T_{b} of the plasma discharge more than 7000 K.

The pulsed xenon lamp contains at least 70% xenon in a gas medium of the discharge channel.

The discharge channel of the pulsed lamp has a straight or curved shape.

In particular, the discharge channel has a diameter varying along its length.

Preferably, the largest diameter of the quartz channel does not exceed 20 mm.

The above-given ratio of the geometric parameters of the quartz channel of the UV lamp to the parameters of the discharge circuit does not allow the temperature of the inner surface of the quartz wall to rise above 2000-2300° C., which contributes to increasing the efficiency of generation of UV radiation and increasing the service life of the pulsed lamp.

### BRIEF DESCRIPTION OF DRAWINGS

The proposed solution is explained by FIGS. 1-3.

FIG. 1 shows a power supply circuit of a pulsed UV lamp.

FIGS. 2a-2c show examples of shapes of a discharge channel of the pulsed UV lamp, namely: FIG. 2a shows the straight channel, FIG. 2b shows the channel having a variable cross-section, FIG. 2c shows the channel having a curved shape.

FIG. 3 shows the results of UV degradation tests in the spectral region of 200-300 nm.

### DETAILED DESCRIPTION OF THE INVENTION

To perform the method for generating high-intensity pulses of continuous-spectrum UV radiation, a tubular pulse lamp 1 having quartz walls is filled with inert gas having a low coefficient of thermal conductivity, mainly xenon, or a mixture of such gases with a xenon content of at least 70%.

A plasma discharge having a power and duration sufficient for its transition into the form of a constricted arc is produced, in response to a command from a control unit (not shown in the figures), in the interelectrode gap of the discharge channel of the pulse lamp 1 by means of a high-voltage pulse current source 2.

The constricted arc discharge is formed in a continuous burning mode or prior to each main discharge pulse at least 10⁻³ second after the end of the high-current stage of the main discharge, since 10⁻³ second is the characteristic time of formation of the constricted arc discharge.

Thus, the control unit records the presence of a required current value in the discharge circuit comprising a power supply unit 3, a storage capacitor 4 and a switch 5, and signals the opening of the switch 5 with a delay of at least 10⁻³ second. The main discharge pulse is suppled in the form of a high-current discharge of the capacitor 4 with a current density of not less than 3 kA/cm², providing brightness temperatures of the plasma of heavy noble gases more than 7000 K. The main discharge pulses are supplied with a repetition rate of not more than 200 Hz. In this way, a continuous-spectrum radiation pulse is produced.

In this case, the pulsed lamp 1 limited by the quartz walls should, when operating in the stroboscopic mode, have geometric parameters of the discharge plasma channel (diameter and length) related to the parameters of the discharge circuit as follows:

$$dl > 1 {0}^{3} ( 0.2 + k ) {U}^{2} {C}^{3 / 4} {L}^{- 1 / 4} ,$$

where d is the diameter of the channel of the lamp 1, cm, l is the length of the channel of the lamp 1, cm, U is the voltage on the storage capacitor 4, V, C is the capacitance of the storage capacitor 4, F, L is the inductance of the discharge circuit, H, k=2.5*10⁻⁵ (T_{b}−7000 K) is the dimensionless coefficient that takes into account the increase in absorption of UV radiation at brightness temperatures T_{b} of the plasma discharge more than 7000 K.

One of the conditions for ensuring long-lasting operation of the pulsed xenon lamp 1 is the mode of its operation: a pulsed and average electric power, a pulse duration and discharge channel dimensions. It is known that the magnitude of a temperature jump during pulse heating of the wall is influenced by the thermophysical properties of the material, an absorbed power and a duration of exposure. Consequently, to increase the efficiency of UV radiation generation, it is required to coordinate the operational modes of the lamp 1, at which the temperature of the inner surface of the quartz wall does not exceed 2000-2300° C., with the geometrical parameters of its discharge channel.

The above-indicated ratio between the geometric parameters of the quartz channel of the lamp 1 and the parameters of the discharge circuit, which determine the efficiency of UV radiation for a particular discharge channel and characterize the operational mode of the lamp 1, does not allow the temperature of the inner surface of the quartz wall to exceed 2000-2300° C. Exceeding these values of the wall temperature by reducing the size of the channel or by excessively increasing a specific power will cause the quartz wall to melt and evaporate, which will be a sufficient condition for a sharp intensification of photochemical reactions of the destruction of quartz glass with the formation of quartz compounds (e.g., SiO) shielding UV radiation and the generation of oxygen. This in turn will start the oxidation of electrodes, which will cause their increased erosion and, as a consequence, contamination of a quartz tube. These are the main processes leading to a reduction in the service life of pulsed xenon lamps and a decrease in the efficiency of UV radiation generation.

A constricted discharge allows the initiation of a high-current main discharge strictly along the axis of the discharge channel. In this case, it (the constricted discharge) intensively expands with the formation of a shock wave that displaces xenon to the channel wall and forms a shock-compressed layer that protects it from hard vacuum ultraviolet radiation and excludes its contact with the hot discharge plasma. In known methods and devices, a non-axisymmetric (near the wall) discharge is formed, while providing a local zone of high specific power and the existence of the contact of the plasma with the wall until the discharge plasma is completely recombined. The equalization of the specific power value on the wall in the case of using a preliminary constricted discharge occurs only when the discharge channel is fully filled. In this case, the radiation fluxes absorbed by the wall in the presence of shock-compressed xenon are lower due to the shielding of radiation with wavelengths shorter than the ionization potential of xenon, and there are no effects of quartz destruction caused by the interaction with fast (high-energy) electrons of the discharge plasma. Consequently, the constricted discharge allows increasing the specific power of the discharge compared to the known methods for initiating a discharge near the channel wall, which allows increasing the efficiency of UV radiation. A further increase in the specific power leads to an increase in the values of the radiation fluxes absorbed by the wall, which will lead to jumps in the wall temperature of more than 2300° C. and cause the wall evaporation, the development of photochemical transformations and, consequently, a sharp decrease in the service life of the lamp. Therefore, the dimensions of the discharge channel must be sufficient for the implemented pulsed powers of the discharge and its duration.

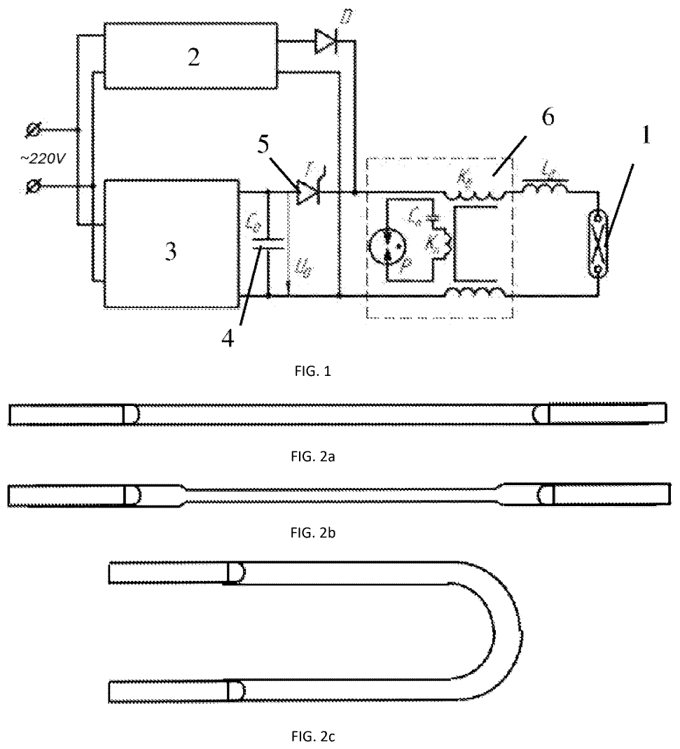

The device for generating high-intensity pulses of continuous-spectrum UV radiation (FIG. 1) comprises the pulse lamp 1 filled with an inert gas having a low thermal conductivity coefficient, mainly xenon, or a mixture of such gases with a xenon content of at least 70% in the gas medium of the discharge channel with the quartz walls. The pulse lamp 1 is connected to the power supply unit 3 and the storage capacitor 4 through the switch 5 to form the discharge circuit. The generating device also comprises an initiation unit 6—an ignitron arranged between the switch 5 and the lamp 1, the current source 2 for forming a constricted arc discharge, and the control unit (not shown in the figures).

As already described above, the achievable technical result provides the ability to form a constricted arc discharge prior to the main discharge pulse, as well as the relationship of the geometric parameters of the discharge channel of the pulsed lamp 1 with the parameters of the discharge circuit by the following ratio:

$$dl > 1 {0}^{3} ( 0.2 + k ) {U}^{2} {C}^{3 / 4} {L}^{- 1 / 4} ,$$

where d is the diameter of the channel of the lamp 1, cm, l is the length of the channel of the lamp 1, cm, U is the voltage on the storage capacitor 4, V, C is the capacitance of the storage capacitor 4, F, L is the inductance of the discharge circuit, H, k=2.5*10⁻⁵ (T_{b}−7000 K) is the dimensionless coefficient that takes into account the increase in absorption of UV radiation at brightness temperatures T_{b} of the plasma discharge more than 7000 K.

The above-given limitation of the discharge channel dimensions is valid for average specific powers of no more than 20 W/cm² during the lamp operation with natural cooling in air.

In this case, the shape of the discharge channel of the pulsed lamp 1 is made straight or curved (FIGS. 2a-2c). And the diameter of the channel in some embodiments can vary along its length (FIG. 2b).

The lamp 1 is made by means and methods known from the prior art.

The operation of the proposed device is described below.

The formation of the plasma discharge by a high-voltage pulse from the current source 2 with its subsequent transition into the constricted arc form in the interelectrode gap of the discharge channel of the xenon pulse lamp 1 with the quartz walls is carried out as follows. Initially, the open-circuit voltage of the current source 2 is applied to the electrodes of the pulsed lamp 1 in response to a command from the control unit, and the voltage value depends on the xenon pressure and the length of the discharge channel in the lamp. A gas gap is broken down using the high-voltage pulse. A pilot arc current begins to flow through the channel. The current continues to increase, the arc power increases until overheating instability occurs—discharge constriction occurs—a thin conducting channel is formed strictly along the axis of the quartz channel.

The channel formation time is 10⁻³ second. The presence of the required pilot arc current value is recorded by the control unit and a signal is sent to open the switch 5 of the discharge circuit to supply the main discharge pulse with a delay of at least 10⁻³ second. The storage capacity of the capacitor 4 begins to discharge into the arc discharge constricted along the axis of the quartz channel. The shape of the electric power pulse deposited in the plasma is determined by the parameters of the discharge circuit: the values of the working capacity, voltage and inductance. The main discharge pulse must have a current density of more than 3 kA/cm² to achieve brightness temperatures of the plasma in the discharge channel more than 7000 K.

The most effective energy input to the plasma is realized by discharges close to critical. In this case, the shape of the electric power will be close to a triangle. The channel expands at a constant speed with the formation of a shock wave. The shock wave displaces the gas to the quartz wall, compressing it. A layer of shock-compressed xenon is formed between the wall and the shock wave front, which protects the wall from the impact of the high-temperature shock wave plasma and shields the short-wave vacuum UV radiation of the xenon plasma. This reduces the level of heat load on the inner surface of the quartz wall and allows to significantly increase the discharge power and, accordingly, the brightness temperature and the yield of UV radiation.

At the end of the discharge, the plasma recombines in 10⁻³ second, the switch 5 closes, the capacitor 4 begins to charge, the arc current continues to flow with the formation of a constriction along the axis of the discharge channel, and by the time the capacitance is charged, the switch 5 opens and a high-current discharge flows similar to that described above.

The pilot arc does not contribute to the increase in the UV radiation yield, so the costs of its formation are parasitic. At low pulse repetition rates (e.g., less than 1 Hz), the pilot arc is initiated 10⁻³ second right before the high-current discharge, which is a time sufficient to form the constricted discharge form. Given the discharge plasma recombination time and the discharge constriction formation time, the maximum pulse repetition rate is limited to 200 Hz, which determines the degree of the temperature gradient between the quartz tube walls.

Considering that the main contribution to the radiation of high-current discharges in xenon is given by the bremsstrahlung of free electrons, the spectral distribution of the radiation energy will be close to the Planckian one. Consequently, the efficiency of the UV radiation yield increases with increasing the plasma temperature or the specific power of the main discharge. The analysis of the dependence of the parameters of the discharge circuit and the lamp channel, i.e., dl>10³ (0.2+k)U²C^{3/4}L^{-1/4}, shows that an increase in the maximum specific discharge power for specific dimensions of the discharge channel of the lamp is possible by increasing the voltage on the storage capacitor and by reducing the capacity and inductance of the discharge circuit. It is obvious that an increase in the voltage will lead to a significant (quadratic) decrease in the capacity of the capacitor 4 and, accordingly, a reduction in the discharge duration and, as a result, an increase in the specific power—an increase in the brightness temperature of the plasma. A decrease in the inductance due to the removal of the initiation coil from the discharge circuit will lead to a reduction in the discharge duration and, accordingly, an increase in the specific power.

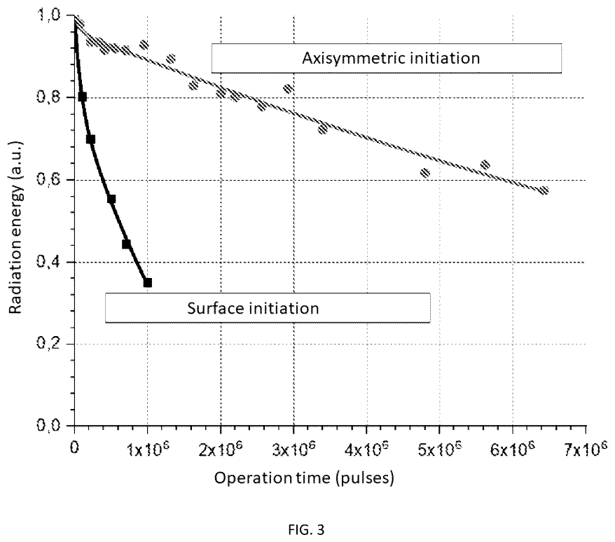

The proposed technical solution was used to study the durability of pulsed xenon lamps with a discharge gap of 12 cm and an internal diameter of 0.5 cm of straight geometry. The discharge circuit capacitor having a capacity of 60 μF was charged to a voltage of 1.4 kV, the circuit inductance was 53 μH. The lamps were tested when operating at a pulse repetition rate of 3.3 Hz in air without forced cooling. One half of the lamps were tested with a discharge circuit with sequential ignition; the other half of the lamps were tested with a similar circuit, but the operation was carried out with a constantly operating arc constricted along the axis of the quartz channel, onto which the storage capacitor was discharged at the same frequency of 3.3 Hz. The discharge current, pulse duration and radiation characteristics of the xenon plasma of the tested lamps were identical in both discharge initiation methods. The results of UV radiation degradation tests in the spectral range of 200-300 nm are shown in FIG. 3. It is evident that the proposed technical solution allows increasing the service life of straight-geometry lamps by 10 or more times.

Similar service life tests were conducted with U-shaped pulsed xenon lamps. The discharge gap length was 280 mm, and the inner diameter of the quartz tube was 7 mm. The capacity of the storage capacitor was 100 μF, the operating voltage was 2800 V, and the inductance of the discharge circuit was 39 μH. The lamps were tested when operating at a pulse repetition rate of 2.5 Hz in air without forced cooling. The discharge current, pulse duration, and radiation characteristics of the xenon plasma of the tested lamps were identical in both discharge initiation methods. The use of a constantly operating arc constricted along the axis of the quartz channel allowed increasing the service life of complex-shaped lamps by 8-9 times.

To check the relationship between the geometric parameters of the pulsed lamp and the parameters of the discharge circuit, designated by the ratio dl>10³ (0.2+k)U² C^{3/4}L^{-1/4}, the durability of pulsed xenon lamps with a discharge gap of 12 cm and an internal diameter of 0.5 cm of straight geometry was studied. The capacitor of the discharge circuit with a capacity of 120 μF was charged to a voltage of 1.38 kV, the inductance of the circuit was 7 μH. The lamps were tested when operating at a pulse repetition rate of 3.3 Hz in air without forced cooling and with a constantly operating arc constricted along the axis of the quartz channel. The measured brightness temperature was 9500 K. The values of the geometric characteristics recommended by the proposed ratio were 10.8 cm², which is greater than the actual ones—6 cm². As a result of the tests, the durability of the tested lamps was reduced by 3-4 times. Thus, it was possible to confirm the achievement of the technical result.

Thus, the use of the proposed group of inventions will allow one to increase the efficiency of UV radiation generation by pulsed xenon lamps and extend their service life.

1. A method for generating high-intensity pulses of continuous-spectrum UV radiation, comprising:
forming, by a current source, a constricted arc discharge in an interelectrode gap of a discharge channel of a pulsed xenon lamp with quartz walls, and
supplying, to the discharge channel though a switch of a discharge circuit, a main discharge pulse having a current density sufficient to achieve plasma brightness temperatures of more than 7000 K in the discharge channel, thereby generating a pulse of continuous-spectrum radiation with ultraviolet output;
wherein the discharge channel of the pulsed lamp has geometric parameters related to parameters of the discharge circuit as follows:
$$dl > 1 {0}^{3} ( 0.2 + k ) {U}^{2} {C}^{3 / 4} {L}^{- 1 / 4} ,$$
where d is a diameter of the discharge channel of the lamp, cm, l is a length of the discharge channel of the lamp, cm, U is a voltage on a storage capacitor, V, C is a capacitance of the storage capacitor, F, L is an inductance of the discharge circuit, H, k=2.5*10⁻⁵ (T_{b}−7000 K) is a dimensionless coefficient that takes into account an increase in absorption of UV radiation at brightness temperatures T_{b} of a plasma discharge more than 7000 K.

2. The method of claim 1, wherein the constricted arc discharge is formed in a continuous burning mode or at least 10⁻³ second prior to each main discharge pulse.

3. The method of claim 1, wherein the main discharge pulse is supplied with a current density of at least 3 kA/cm².

4. The method of claim 1, wherein main discharge pulses are supplied with a repetition rate of not more than 200 Hz.

5. A device for generating high-intensity pulses of continuous-spectrum UV radiation, comprising:
a pulsed xenon lamp having quartz walls of a discharge channel, the pulsed xenon lamp being connected to a power supply and a storage capacitor through a switch to form a discharge circuit;
an initiation unit;
a current source for forming a constricted arc discharge; and
a control unit;
wherein the discharge channel of the pulsed lamp has geometric parameters related to parameters of the discharge circuit as follows:
$$dl > 1 {0}^{3} ( 0.2 + k ) {U}^{2} {C}^{3 / 4} {L}^{- 1 / 4} ,$$
where d is a diameter of the discharge channel of the lamp, cm, l is a length of the discharge channel of the lamp, cm, U is a voltage on the storage capacitor, V, C is a capacitance of the storage capacitor, F, L is an inductance of the discharge circuit, H, k=2.5*10⁻⁵ (T_{b}−7000 K) is a dimensionless coefficient that takes into account an increase in absorption of UV radiation at brightness temperatures T_{b} of a plasma discharge more than 7000 K.

6. The device of claim 4, wherein the pulsed xenon lamp contains at least 70% xenon in a gas medium of the discharge channel.

7. The device of claim 4, wherein the discharge channel of the pulsed lamp has a straight or curved shape.

8. The device of claim 4, wherein the discharge channel has a diameter varying along the length of the discharge channel.

9. The device of claim 7, wherein the largest diameter of the quartz channel does not exceed 20 mm.
